(19) United States
(12) Patent Application Publication
(10) Pub. No.: US 2007/0067185 A1
(43) Pub. Date: Mar. 22, 2007

(54) Medical diagnosis feedback tool

(76) Inventor: Mark J. Halsted, Wyoming, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 11/522,847

(22) Filed: Sep. 18, 2006

Related U.S. Application Data
(60) Provisional application No. 60/717,923, filed on Sep. 16, 2005.

(51) Int. Cl. G06Q 10/00; G06F 19/00

(52) U.S. Cl. 705/2; 705/3

(57) ABSTRACT

A computer implemented medical event notification system and method for a healthcare facility is provided. The system includes at least one user computer and at least one computer server operatively coupled for communication over a computer network. The computer server operates at least a portion of a medical notification software tool and has access to a patient record database containing a plurality of patient records. The method includes a step of monitoring the plurality of patient records by the medical notification software tool for at least one predetermined event; and includes one or both of the following steps: (a) upon detecting the occurrence of the at least one predetermined event by the medical notification software tool, automatically pushing a notification of the detected predetermined event occurrence to an authorized user of the medical information even notification system; and (b) upon detecting the non-occurrence of the at least one predetermined event by the medical notification software tool in a predetermined window of time, automatically pushing a notification of the detected predetermined event non-occurrence to an authorized user of the medical information event notification system. A critical element to this system and method is that the notification is automatically “pushed” to the authorized user; that is, the authorized user is not required to query the system for the occurrence or non-occurrence of the event.

### CROSS REFERENCE TO RELATED APPLICATIONS

The present application claims the benefit from U.S. Provisional Application Ser. No. 60/717,923, filed Sep. 16, 2005, the entire disclosure of which is incorporated herein by reference.

### BACKGROUND

Upon completing clinical training, the amount of feedback physicians receive on the quality of their clinical performance declines significantly. Whereas in training they are closely supervised, upon graduation they no longer receive consistent feedback on their performance. As they move into clinical practice, they are often unaware of the accuracy of their diagnoses, sensitivity in detecting pathology, and specificity in limiting differential possibilities for findings. This problem is particularly acute for specialists such as emergency department physicians, radiologists, and others who often have only a single contact event with each patient. Since they tend not to see patients over multiple visits, such specialists do not learn the outcomes of the majority of their diagnostic and treatment decisions, and they do not learn from their own mistakes. Without such feedback, physicians may make incorrect diagnoses or deliver inappropriate treatments again and again. Even cases for which they actively seek to receive feedback are often lost to follow-up, due to an ever-increasing workload and the lack of easily accessible tools to track patient outcomes.

This failure to close the feedback loop limits physicians' on the on-the-job learning opportunities. Whereas clinical experiences could, if physicians learned from successes and failures, potentially provide a rich medium for on-going educational opportunities, the system often fails a physician by not providing easy access to patient outcome information. By practicing in an information vacuum, the physician misses countless opportunities to improve. These missed opportunities for physician learning translate into missed opportunities to improve the quality of patient care. As a result, the quality of patient care suffers.

Some physicians try to address this problem by listing interesting cases on note-cards (patient name, record number, date and a note explaining the reason to follow up) that they carry around with them in their pockets. Periodically, they can manually flip through the note cards to find cases for which they think an update may be present in the patient records, and then query the manually selected patient records to check for an update, such as a radiology, operative, or pathology report. Sometimes the desired information will be present. Oftentimes it will not.

Another traditional concept for promoting continuing education and/or training of physicians is collaboration. Many times, medical students and/or practicing physicians have the opportunity to participate in regular group discussion sessions, also called conferences, which tackle particularly puzzling or interesting cases. If the primary or treating physician has been unable to determine an appropriate treatment plan or diagnosis in a particular case, the collaboration facilitated by such a group provides that physician access to the collective experience and knowledge of the entire group. In other instances, a physician may utilize discussion sessions to present a particularly rare or interesting case to his or her colleagues. Such collaboration promotes education of even experienced physicians, as it allows all the members of the group to benefit educationally from a single, isolated case. In yet another example, discussion groups may be utilized to bring together physicians of varying specialties to tackle cases presenting medical conditions or diseases that may benefit from the collaboration of several areas of expertise.

Although such discussion groups clearly provide significant clinical, diagnostic and education benefit, their everyday practicality is inherently limited. Even if a particular group meets once per week, the vastness of each physician-member's workload means that most cases will not gain access to the benefits associated with this level of collaboration. Further, many intervening factors may arise within the week that drastically change the nature of a particular case—e.g. test results, adverse reactions to treatments, development of additional medical conditions. A treating physician may not have access to discussion group collaboration within the time period necessary to react to such changes. Finally, the average physician's workload also necessarily limits the number of live, scheduled meetings that any physician may attend in any given week.

Another recognized problem in medical practice is that often-times a physician, during or after his or her workup, will recommend that the patient have a follow-up diagnostic exam, a lab test performed, and/or a follow up physical exam. Unfortunately, however, a significant percentage of such recommended follow-up events do not actually occur. Allowing such recommended follow-up exams to “slip through the cracks” hurts everyone by delaying diagnosis and treatment, ultimately degrading the quality of patient care and increasing medical costs for everyone.

Another inefficiency of the current scheduling system is the procedure available to an ordering physician for ordering follow-up testing recommended by a reviewing physician or specialist. First, the primary or treating physician orders an initial test, examination or procedure to be performed or reviewed by a specialist. The specialist then conducts the test, examination or procedure and prepares a report to the treating physician. Among the notes contained in the report, the specialist may include a recommendation for one or more follow-up tests, examinations or procedures to be performed. Traditionally, if the treating physician decides to follow a particular recommendation, he or she must complete and submit a separate requisition ordering the recommended test, examination or procedure. Oftentimes these requisitions are in hardcopy paper form. Even if the physician has office staff available to assist with this process, errors in communication can occur between physicians and staff members, causing critical tests not to be completed within a reasonable time frame. Such juggling of papers and reports may also lead to the inadvertent ordering of duplicative tests, exams or procedures. Each year, it is believed that such duplication results in significant waste—adding to rising healthcare costs for patients, health systems, and the healthcare industry as a whole—not to mention additional and unnecessary pain and inconvenience for the particular patients.

Not surprisingly, it is very difficult for a treating physician to organize and process the vast number of paper reports, recommendations and order requisitions that may cross his or her desk each day. Such a system presents significant risk of error in the follow-up orders; failing to order a recommended follow-up test, exam or procedure all together; or inadvertently ordering duplicative tests, exams or procedures. Another problem with the traditional follow-up ordering procedure is that it takes a significant amount of time for a treating physician to complete these requisition forms, while much of this time is spent simply copying the information included in the report onto the form.

Therefore, the patient, the caregivers, the medical facilities, and the healthcare system as a whole would benefit from a system that improves the effectiveness with which follow-ups exams and other healthcare diagnostic or therapeutic events are tracked, ensuring that recommended follow-up exams, tests, and appointments are completed on time and that they are not unnecessarily duplicated, and facilitating easy and efficient follow-up ordering.

It will therefore be appreciated that the embodiments of the invention described below address many broad needs, including but not limited to: improving the accuracy, timeliness, and quality of feedback that physicians receive on their own performance; promoting continual collaboration among physicians; helping to ensure that all recommended diagnostic and therapeutic interventions are performed in a timely manner; helping to ensure that diagnostic and therapeutic interventions are not unnecessarily duplicated; and facilitating easy and efficient follow-up ordering of tests, examinations and procedures.

### SUMMARY

A computer implemented medical event notification system and method for a healthcare facility is provided. The system includes at least one user computer and at least one computer server operatively coupled for communication over a computer network. The computer server operates at least a portion of a medical notification software tool and has access to a patient record database containing a plurality of patient records. The method includes a step of monitoring the plurality of patient records by the medical notification software tool for at least one predetermined event; and includes one or both of the following steps: (a) upon detecting the occurrence of the at least one predetermined event by the medical notification software tool, automatically pushing a notification of the detected predetermined event occurrence to an authorized user of the medical information event notification system; and (b) upon detecting the non-occurrence of the at least one predetermined event by the medical notification software tool in a predetermined window of time, automatically pushing a notification of the detected predetermined event non-occurrence to an authorized user of the medical information event notification system.

A critical element to certain exemplary embodiments of this system and method is that the notification is automatically “pushed” to the authorized user (e.g., the authorized user is emailed the notification, the authorized user is paged with the notification, the authorized user is sent a cellular text message with the notification, and/or the authorized user is sent an electronic instant message with the notification, etc.); that is, the authorized user is not required to query the system for the occurrence or non-occurrence of the event. By automatically pushing the notification to the user, the user only needs (in certain instances) to establish or initially subscribe to the monitoring and can then ‘forget’ about it because the system will automatically send the user the appropriate notification without requiring the user to continuously look for it or continuously query the system.

### BRIEF DESCRIPTION OF THE DRAWINGS

FIG. 1 is a diagram showing an exemplary integration of various databases and hardware.

FIG. 2 is an diagram showing exemplary database integration.

FIG. 3 is a flow chart of an exemplary embodiment of the present invention.

FIG. 4 is a flow chart of an exemplary feature of the present invention.

FIG. 5 is an exemplary search screen.

FIG. 6 is an exemplary results screen.

FIG. 7 is an exemplary results screen.

FIG. 8 is an exemplary subscription screen.

FIG. 9 is a flow chart of an exemplary feature of the present invention.

FIG. 10 is an exemplary log screen.

FIG. 11 is an exemplary database object diagram.

FIG. 12 is an exemplary email group setup page.

FIG. 13 is an exemplary electronic message report.

FIG. 14 is an exemplary communication template.

FIG. 15 is an exemplary department account setup page.

FIG. 16 is an exemplary electronic message report.

FIG. 17 is an exemplary order request page.

### DETAILED DESCRIPTION

Embodiments of the present invention improve the accuracy and efficiency of the everyday tasks of diagnosing, collaborating and scheduling among a plurality of healthcare providers, staff, administrators, patients and family members of patients across a single healthcare system or a network of healthcare systems. To do this, an exemplary embodiment of the present invention utilizes an electronic medical records system, search processes and/or natural language processing models and brokerage of existing electronic mail accounts.

Embodiments of the present invention address the current lack of an easy and automated method for healthcare providers, staff and administrators to “track” future developments and outcomes of particular patient cases. It could be extremely beneficial for an individual physician to have the capability of tracking particular cases in which he or she was professionally involved. For instance, a radiologist may want to know whether her initial interpretation of a mass was accurate; an emergency room physician may wish to find out how a patient he saw and had admitted to the intensive care unit did after leaving the emergency room; a pediatrician may want to follow the progress of her patient while the patient is in the hospital so she is up to speed when the patient returns to her care in the outpatient setting.

In addition to the treating or reviewing physician, other physicians in the same department, practice group or discussion group or may also desire to track the progress of particular cases. For example, the head of a radiology department may want to know whether a report provided by an associate radiologist was accurate; an entire group of physicians treating a single patient may wish to be informed of test results, labs or exam results procured by each other; or a member of a discussion group may be interested in learning the ultimate outcome of a case discussed during a past session. It may also be beneficial for health system administrators to have this tracking capability, by providing increased quality and cost control, malpractice monitoring, and system-wide notification of cases requiring quarantine or other special procedures.

Alternatively, health care providers may find it beneficial to track particular events for a number of patients. For example, the head of the radiology department may wish to be provided with all radiology reports for all non-plain radiograph exams for all patients examined by a department radiologist during a particular period of time. Such event-based tracking capability could also significantly foster education, quality control, malpractice monitoring and the like.

Embodiments of the present invention thus allow a single physician, as well as groups of practitioners, staff and/or administrators to “subscribe” to specific patients. Such subscription would give the individual or group automatic notification of future events and outcomes regarding the selected patient. Alternatively, embodiments of the present invention allow a single physician, as well as groups of practitioners, staff and/or administrators to “subscribe” to specific events regarding a number of patients. The group of patients tracked in this manner may be defined by condition, treating department or physician, age, date of treatment, etc.

Embodiments of the present invention also provide a mechanism to track outcomes which are unexpected, by comparing anticipated diagnoses with actual diagnoses. For instance, a radiologist may not include a final pathologic diagnosis in his initial differential diagnosis. The system would compare the radiologist's report with the final pathologic diagnosis and if there were a significant discrepancy it would alert the radiologist. To accomplish this, as an example, the system may utilize simple search technology or even natural language processing algorithms in combination with expert rules to determine the discrepancies between the diagnoses. If the expert system determines the discrepancies to be of significance, the system would be automatically configured to notify the first physician.

Specifically, in one exemplary embodiment, simple search technology may be used to compare the text of sequential reports for discrepancies. One process to accomplish this is for the system compare the text of an initial report to an expert list of pathologic diagnoses, and identify the diagnosis in the initial report. The system would then search the subsequent report for a matching diagnosis. If the system does not find a matching diagnosis, it would automatically notify the physician who dictated the initial report. Alternatively, the system could simply compare the portions of each report designated by the system as diagnosis segments. If the text of these segments does not match, the initial physician would be notified of the discrepancy.

Yet another exemplary process by which the present invention may accomplish diagnosis comparison is with the use of natural language process models in conjunction one or more sets of expert rules. Specifically, current natural language processing models are capable of extracting the diagnostic terms included in radiologists' reports, such as “Teratoma”, a type of tumor. The invention leverages such an engine to extract the terms offered as potential diagnoses in the original report (the “differential diagnosis”), and compares them to terms appearing in subsequent radiology reports, operative reports, pathology reports, hospital discharge summaries, clinic notes, etc. A suitable natural language processing engine tested for such purposes is the Medical Language Extraction and Encoding System (MedLEE) available through Columbia University. If, for instance, a pathology report specifies a final diagnosis not included in the differential diagnosis of the original radiology report, the system notifies the first radiologist of the discrepancy, offering a link to the original radiology report and to the subsequent pathology report. That radiologist can then re-examine the case and learn from her mistake (in this example, the omission of the actual diagnosis from her original differential diagnosis). Again, subscriptions can be set up to provide such automatic notification to an individual practitioner, a department, a practice group, a discussion group and/or one or more health system administrators.

Furthermore, exemplary embodiments of the system of the present invention will provide a mechanism to alert all prior caregivers, or other designated persons, of interesting and/or rare cases, once they are diagnosed. For instance, if an emergency department physician sees a patient with an unusual constellation of symptoms and findings, that patient is later found to have a very rare condition, the system would notify the emergency department physician of the diagnosis once it is made. To accomplish this, as an example, the system may utilize search technology or natural language processing algorithms in combination with expert rules to monitor for such interesting/rare diagnoses; and if the expert system recognizes the interesting/rare diagnosis, the system could be automatically configured to notify the first department/physician. Additionally, the system could be automatically configured to notify related departments, practice groups, discussion groups or other subscribers. The notification function can also be manually triggered by any caregiver recognizing the case as particularly educational.

Specifically, the natural language processing engine extracts the diagnosis from the reports and compares it to a list of rare conditions. If a final diagnosis, such as indicated in a pathology report, matches one of the list of rare conditions, the system notifies prior caregivers who interpreted diagnostic tests for that case, or other subscriber caregivers, offering them a link to their primary data along with the diagnosis. Those caregivers can then learn better to recognize such a case in the future.

If a caregiver recognizes a case as particularly educational, they can manually trigger similar notification to other caregivers, so that they may benefit from the system-wide data available about the case, again, learning how to recognize similar cases in the future. Group subscriptions may be configured to facilitate notification of established groups of caregivers with specified interests, specialties or educational needs.

Additionally, the system could be used to help alert caregivers of communicable diseases such as pulmonary tuberculosis, once those conditions are diagnosed. This would improve rapid notification of caregivers to seek appropriate testing and therapy themselves, it might help prevent unnecessary transmission of communicable diseases by encouraging rapid, comprehensive, and appropriate isolation of caregivers with whom the patient had had contact. To accomplish this, as an example, the system may utilize natural language processing algorithms in combination with expert rules to monitor for such diagnoses; and if the expert system recognizes the communicable disease diagnosis, the system will be automatically configured to notify all previous caregivers, as well as the health system's administration.

Specifically, similarly to the above, the system extracts diagnoses and compares them to a communicable disease database. A match triggers notification of all caregivers involved, as well as the institutional personnel responsible for containing communicable disease outbreaks and other designated providers, staff and administration. This allows rapid intervention to minimize potential spread of such diseases—such spread is a major public health issue.

Embodiments of the present invention also help caregivers, patients, and authorized family members to ensure that recommended follow-up exams are performed in a timely manner. Specifically, any authorized user can set parameters for recommended exams, lab tests, and follow-up appointments, so that the system notifies the user and/or their designee(s) by email, PDA, cellular, pager, or other technology if any follow-up event is not completed within a specified timeframe.

As an example, if an elderly, debilitated patient in Nebraska is due for an MRI scan to reassess a brain tumor in 3 months, an authorized family-member in New York can log onto the system, and set parameters such that both the family-member and the Nebraska radiology scheduling office will receive an email if no MRI of the brain is performed on the patient between 2 months and 4 months hence. If through cancellations, forgetfulness, transportation problems, or any other issue, the patient's scan is not completed within the 2-4 month timeframe, the system emails the schedulers and the family-member, and they coordinate rescheduling the patient to ensure that the needed exam is completed.

As a further example, if an endocrinologist needs to see a patient back in 3 months with a particular set of lab tests in hand, he can use the system to email his office staff if the labs are not complete one week prior to the appointment date. If the patient fails to complete the labs before then, the staff can contact the patient to get the labs performed, and if necessary reschedule the clinic appointment to give the patient time to have the labs completed. The staff can then fit in another patient and avoid a wasted appointment slot.

Embodiments of the present invention provide an ability to automatically check an ordered test, exam or procedure against a patient's record to identify potential duplication. The system searches a patient's record for similar or matching tests, exams or procedures. A natural language processing model, like those already described, may be used for this function. If a potential duplicate is found, the system automatically sends a message to the ordering user, notifying the user of the potential duplication and asking the user whether he or she still wishes to order the test, exam or procedure.

Embodiments of the present invention provide an ability to facilitate easy and efficient follow-up ordering of tests, examinations and procedures. To do this, as an example, such embodiments provide an electronic reporting method that permits the reporting physician to send an electronic report to the ordering physician that includes a recommendation for further testing, examinations and/or procedures in the form of links. The ordering physician need only click on the link or icon associated with a particular test, exam or procedure to order that test, exam or procedure or begin the process of ordering that same test, exam or procedure. The link or icon may direct the physician to a centralized scheduling database, where the physician electronically schedules the test, exam or procedure. Alternatively, activation of such links or icons may simply send a message to the appropriate scheduling personnel that a test, exam or procedure has been ordered and should be scheduled. The staff member receiving the message would then be the one responsible for entering it into the centralized scheduling database. In a third option, the link or icon would lead the ordering physician to an ordering template, whereby the physician could designate the timeframe or other specific criteria relevant to the test, exam or procedure being ordered. The template would then be electronically submitted to the appropriate personnel who would enter it into the scheduling database.

Exemplary embodiments include a networked computer system which includes software that provides a simple user interface for physicians, departments, practice groups, discussion groups, staff and/or health system administration to identify a specific patient to track. The networked computer system also allows a user to select which parts of the medical record the physician would like the system to monitor; for instance, radiology reports, surgery reports, pathology reports, discharge summaries, etc. The system then automatically monitors those portions of that patient's electronic medical record, and when a new event occurs in one of the areas the user has marked as “track” (such as a new radiology report), the system automatically generates and sends a message (such as an e-mail) alerting the user that the new event has occurred, and provides at least a portion of the report content from that new event (such as a radiology report text and images).

The system also automatically tracks all reports for discrepancies, such as a radiology dictation that does not mention the final diagnosis of a subsequent pathology report, and notifies users of these discrepancies—for instance, emailing the radiologist who omitted the final diagnosis from his report.

All notification requests, email communications and order requisitions are automatically logged into a central audit database. This promotes regulatory, administrative and risk and cost management. Additionally, data encryption and/or firewall security measures are used to protect all information and communications managed by the system.

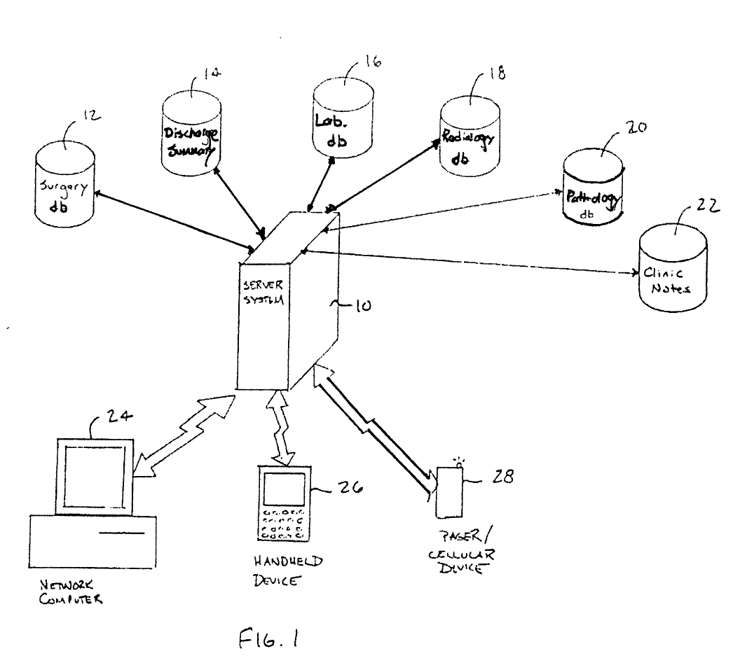

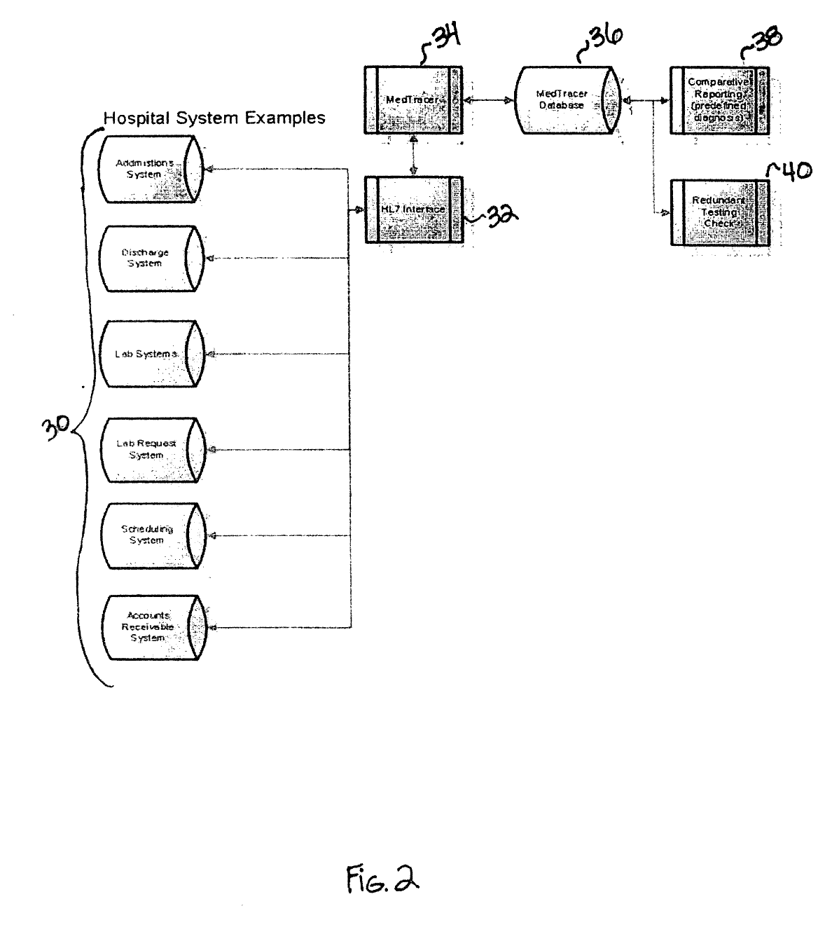

As shown in FIG. 1, the exemplary system is housed on a server 10 that queries a hospital's information systems and databases such as the surgery database 12, the discharge summary database 14, the laboratory (testing) database 16, the radiology database 18, the pathology database 20 and the clinic notes database 22. The system communicates with the physicians and other professionals and staff who are utilizing the system over networked communication devices such as (and without limitation) a networked computer 24, a handheld device (such as a PDA) 26, or a pager/cellular device 28. The computer network can be any type of computer or electronic network such as (without limitation) an intranet, the world-wide-web, another type of global-access data network or a cellular network. As shown in FIG. 2, the exemplary system 34 pulls information from various discrete databases and other sources 30, and pushes this information to a system user according to the user's defined subscription or tracer. A translation interface, such as the HL7 Interface 32, may be used to integrate databases from separate health systems by translating and standardizing the differing terms used by each of the databases. The exemplary system itself may maintain its own database 36 for storing user preferences, tracers, past searches, etc. This database would also facilitate the diagnosis comparison feature 38 and redundant test checking feature 40 already discussed.

A critical element to this exemplary system is that the notification is automatically “pushed” to the user (e.g., the user is emailed the notification, the user is paged with the notification, the user is sent a cellular text message with the notification, and/or the user is sent an electronic instant message with the notification, etc.); that is, the user is not required to query the system for the occurrence or non-occurrence of the event. By automatically pushing the notification to the user, the user only needs (in certain instances) to establish or initially subscribe to the monitoring and can then ‘forget’ about it because the system will automatically send the user the appropriate notification without requiring the user to continuously look for it or continuously query the system

Additionally, the system is capable not only of tracking future results and events for any patient, but it can also allow a user to query back in time for specific records and other information. Specifically, the system provides an interface to filter and select a patient's past reports in real time, returning results relatively instantly to the authorized user, allowing an authorized user to scan through all relevant reports quickly through a single interface. Reports accessible in this way may include radiology, pathology, surgery, clinic notes, discharges summaries, etc. Such an interface saves the user significant time when compared to more traditional search methodology in the health care setting, which usually requires the user to access disconnected information systems with different usernames, passwords, and user interfaces. For any patient, the exemplary system can display all prior results/records or filtered prior results/records from available hospital information systems. For radiology reports, the user can filter by specifying a modality and body part. The user can also specify date ranges to constrain searches.

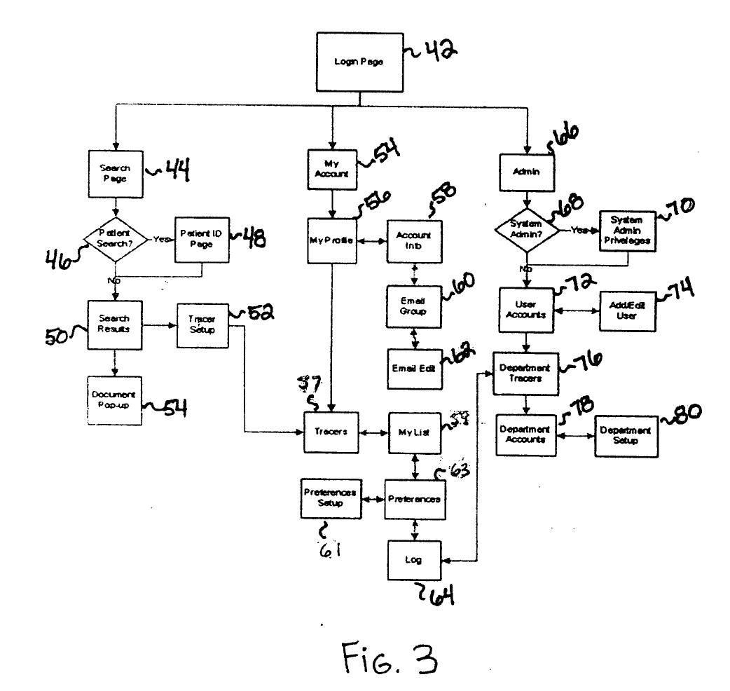

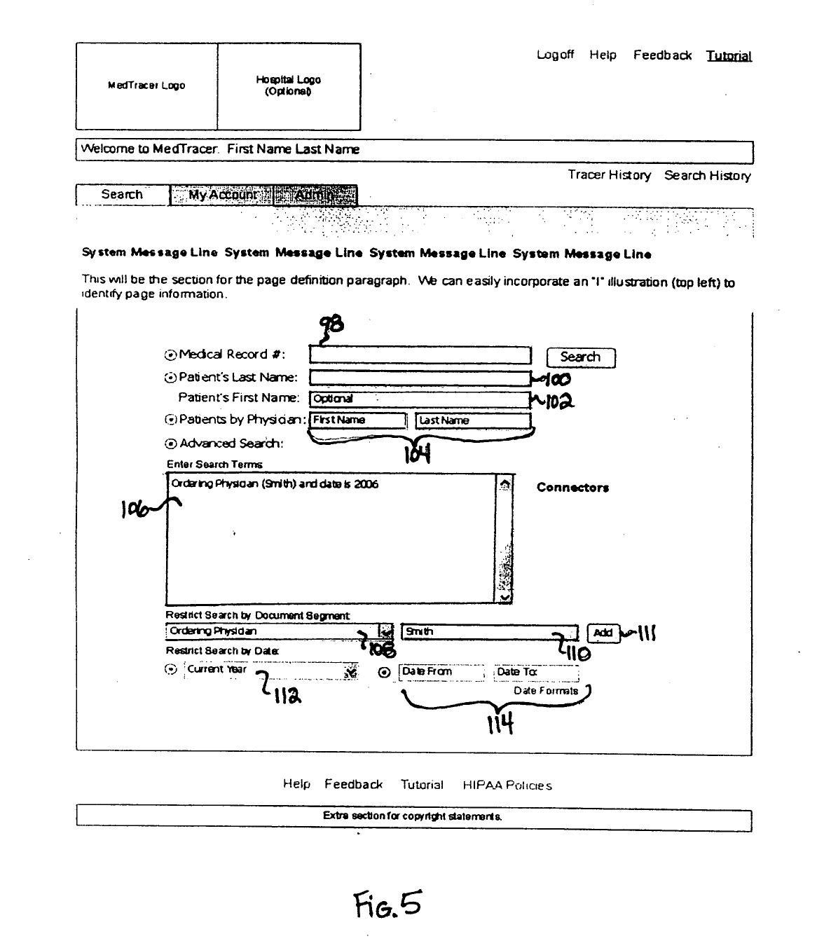

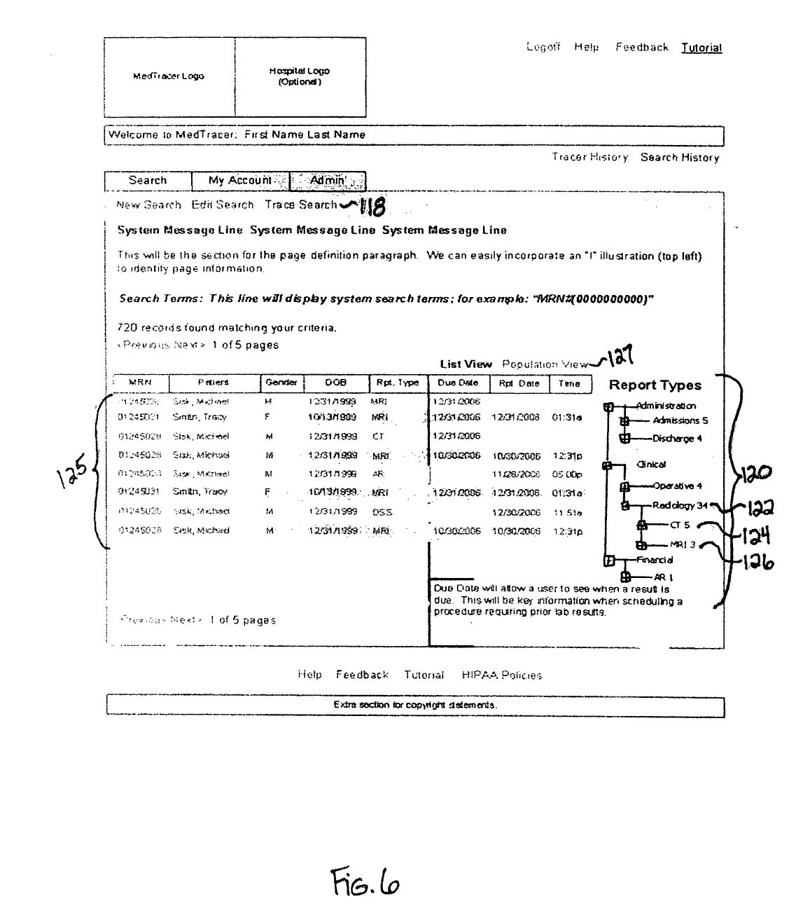

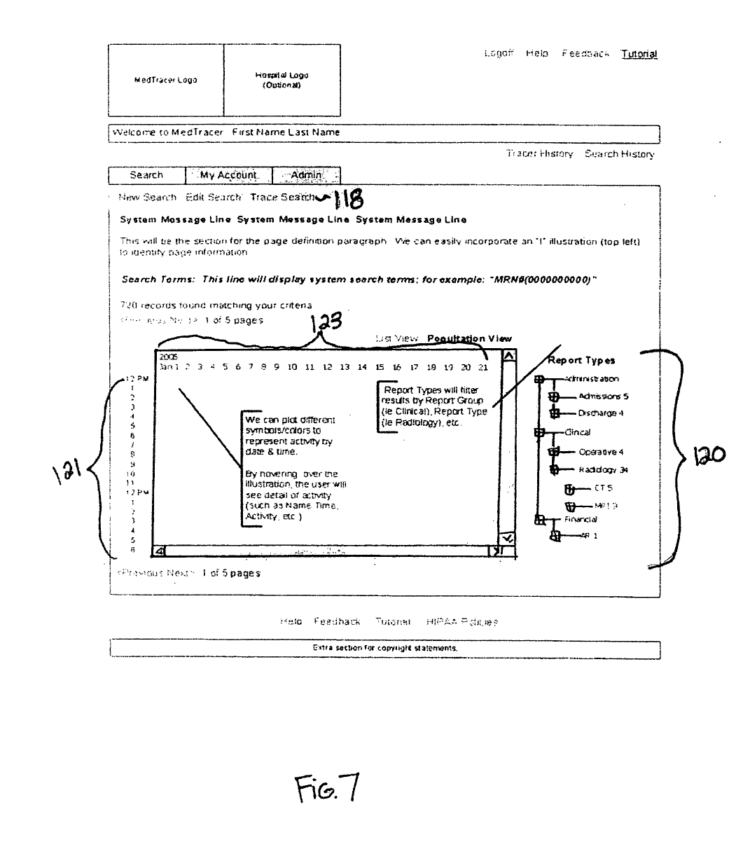

FIG. 3 provides a flow diagram of various exemplary functions of the system that are hereinafter described in detail. Step 42 illustrates the initial Login page for authorizing a user to access the system. As with many secure-access programs, the authorized user may be authorized for all or specific portions of the system, depending upon the user's access status. Upon accessing the system, the user may be taken to or may select one of three initial graphical user interface (GUI) pages as shown in FIG. 3, which includes a “Search” page 44, a “My Account” page 54, and “Admin” page 66. In the Search page 44, which is described in more detail below with respect to FIG. 5, the user will be queried whether or not he or she wishes to conduct a patient search in Step 46. If the user selects a patient search, the user will be taken to a “Patient ID Page” 48 as shown and described below with respect to FIG. 6. The search results are provided in the “Search Results” page 50 as shown in FIG. 7, for example. In the “Search Results” page 50, the user at that point could set up a Tracer Search 52 or request a document(s) from the Patient Record Database 54 as will be discussed in further detail below. Furthermore, the Tracer Set Up 52 and Tracer viewing/editing 57 steps are also described in further detail below.

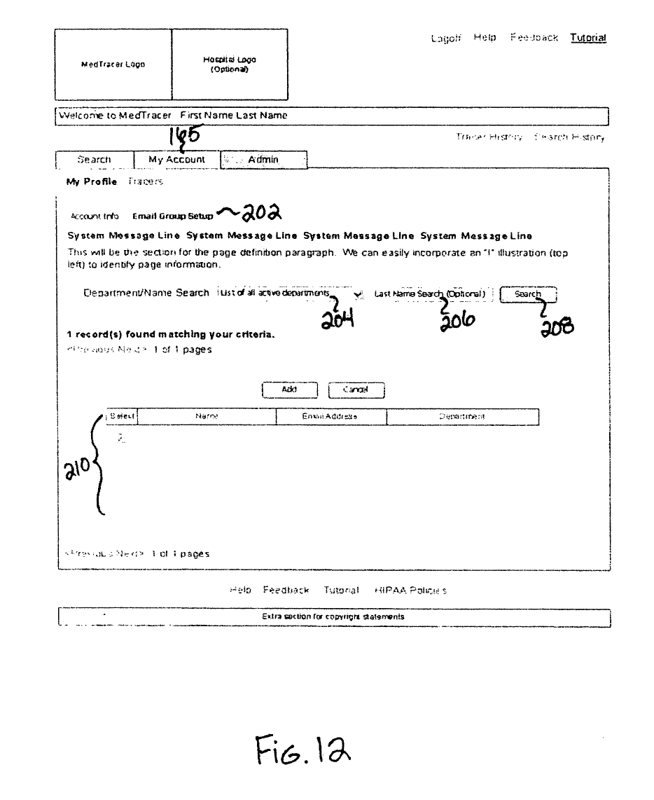

From the “My Account” page 54, the user can go to the “My Profile” page 56. In the “My Profile” page, the user can adjust his or her account information in Step 58, adjust his or her email groups in Step 60, and/or adjust other email options and make edits to emails in Step 62. Examples of these pages and steps are described in further detail below (see FIG. 12 and its corresponding discussion). Further, from the “My Profile” page 56, the user can set up, adjust, or monitor “Tracers” at 57. The user will have a list of established Tracers 59, will have the ability to view 63 and adjust preferences 61 for these Tracer Searches, and will also have the ability to review a log 64 of tracer communications and/or other transactions occurring in the system.

In the “Admin.” page 66, the user will be queried whether or not the user has a system administration status in Step 68. If so, the user is granted system administration privileges 70. Upon determining the administration privileges, the user will be taken to the “User Account” page 72 in which the user can view, add and/or edit the user accounts information 74. From the “User Accounts” page 72, the user can also view the “any department-wide tracers” that have been set up 76. From the “Department Tracers” page, the administrator may also view and/or edit department accounts in the “Department Accounts” page 78 and may set up various aspects of such department accounts in the “Department Set-Up” page 80. Administrator access also allows access to system logs 64.

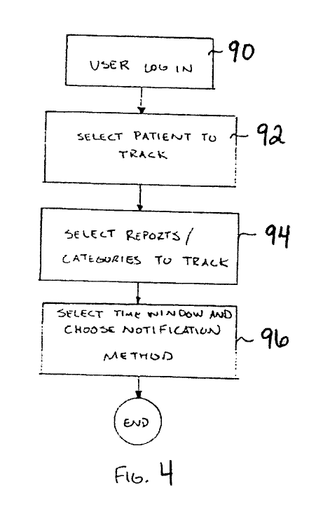

FIG. 4 provides an exemplary flow diagram for establishing a patient record tracking system according to an exemplary embodiment of the present invention. In the first step 90, the user will log on to the system using any known computer-based identification verification method (e.g., username/password) using Login Page 42 of FIG. 3. In the next two steps 92 and 94 the user will select a patient and/or other attribute to track. This may be performed by using Search Page 44. FIG. 5 provides an exemplary screen shot of such a search page. As shown in FIG. 5, the user can enter one or more of a medical record number 98, a patient's last name 100, a patient's first name 102, and/or the name of a physician. Alternatively or additionally, the user may search by entering one or more additional search terms in field 106, connecting such terms using a series of connectors (e.g. Boolean connectors) and/or segment restrictions using fields 108 and 110. Once the search information is entered in the appropriate fields, the search is commenced by clicking “Search” button 116.

FIG. 6 provides an exemplary window in which the system identifies the results that match the physician's search criteria. If more than one patient matches the search criteria, this window will show a number of results 125 matching the criteria entered in the three fields, and the user will be able to select the specific result he wishes to track. The user may choose an alternative view of the results by clicking the “Population View” link 127. The system will then provide the user with a population view as shown in FIG. 7, wherein the results are organized in a two-dimensional layout by corresponding dates 123 and times 121. Such a view will show both the historical results, as well as adding additional results as they are added to any of the integrated databases in real time.

Referring again to FIG. 4, the next step 94 in the process is for the user to select which reports and/or categories to track (for future records) and/or display (for historical records), and/or ensure follow-up. The windows shown in FIGS. 6 and 7 allow the user to filter the results 125 to show only specific reports or categories of reports 120 to track. As can be seen in FIG. 6, the categories of reports with the “+” boxes to the left are capable of being broken into sub categories or specific types of reports. This allows the user to filter results by type, so she sees only reports of interest to her. The “radiology” reports category 122 in this example has been divided into the “CT” sub-category 124 and the “MRI” sub-category 126. It is possible for such sub-categories to be further broken-down into specific exams, tests or procedures. Also, the present invention does not limit the categories of reports to medical reports, as it facilitates tracking of administrative records such as accounts receivable. Such tracers may be especially valuable, for example, for risk management staff to receive administrative and financial reports regarding patients who were not satisfied with their care.

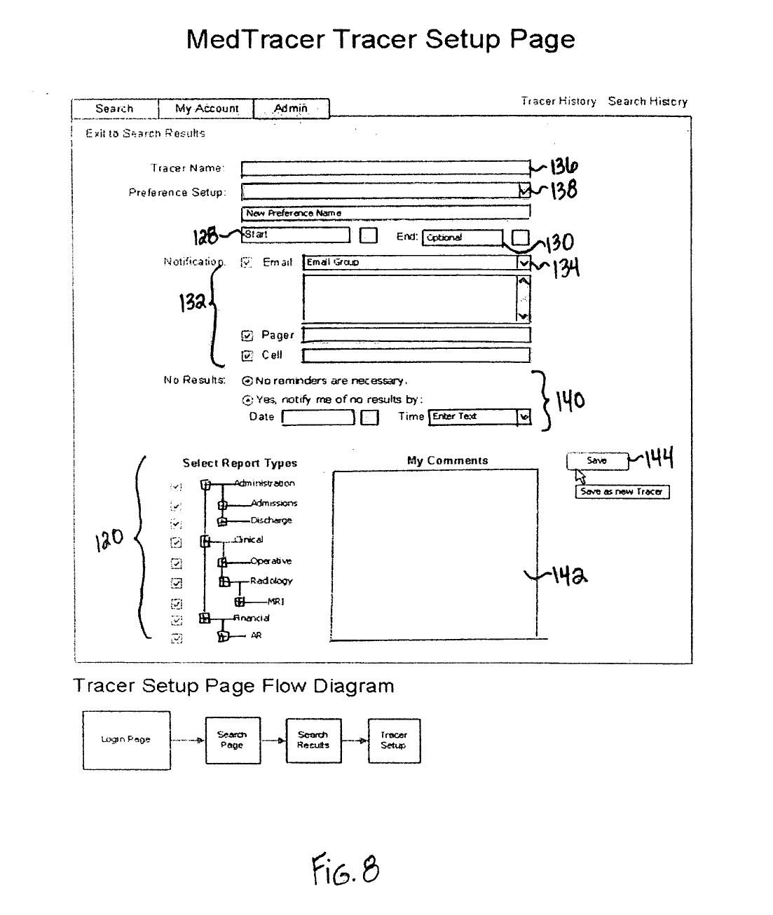

Upon hitting the “Trace Search” button 118 in either of the windows shown in FIG. 6 or 7, the system will advance to step 96 of FIG. 4 (which corresponds to step 52 of FIG. 3) and provide the window as shown in FIG. 8, which allows the user to select a time window for the subsequent tracking to be performed and to choose a notification method(s). Referring to FIG. 8, the window of FIG. 8 includes a listing of the reports and report categories that the user has selected for tracking. In this window, the user is provided with fields 128 and 130 in which the user can then select a window of time in which to track the selected reports, fields 132 in which the user can select the type of messaging methods for notifying the physician of these reports (for example, the physician has selected to be notified by both a pager and by e-mail), and a field 134 in which the user can identify the individual email, email group or email groups to be notified. Additionally the user may name the tracer using field 136 for later reference, choose from a list of pre-set preferences from drop-down box 138 (i.e. these may include pre-saved macros established by the user and pertaining to a particular type of exam or report the user tracks often), and/or add comments to the tracer in field 142. Once these fields are updated, the user can activate the tracer by clicking the “Save” button 144. Once activated, the tracer will provide the user (automatically push to the user) with notification, in real time, of events that meet the constraints of the tracer using the notification method chosen.

As discussed above, the system also provides a method for allowing a physician (or another person such as an authorized family member) to ensure that certain events occur. For example, if a physician recommends a follow up exam, the physician can use the system to assure that the follow up exam occurs; or an authorized family member can utilize the system to ensure that another family member's follow up diagnostic test is completed within an appropriate timeframe.

As another example, when a radiologist recommends a follow-up exam to evaluate a worrisome finding, she wants to ensure that the follow up exam is done. She uses the system to monitor whether the exam is performed in the recommended timeframe: if the exam is not so performed, the system notifies the radiologist, the patient, the scheduling office of the radiology department and/or other responsible departments. The scheduling office contacts the patient so that the patient can be rescheduled for the follow-up exam.

Likewise, the system can be used to ensure that a lab study recommended by an endocrinologist is both performed and that the results are received within a prescribed period of time, so that results are available at the time of a scheduled follow up appointment. As another example, the system can be set up such that, after a scheduling office sets up a test or exam, if the exam is not completed within a set time-frame (for instance, the patient is a no-show or cancels the exam without notifying the office), the system will notify the scheduling office so that another test or exam can be scheduled. The system can also be configured so that patients (a patient's family) can monitor their own care and make sure they follow through in every area where they should by receiving reminders from the system if they fail to complete a given task within a prescribed time frame. As mentioned above, patient proxy, such as son or daughter of an elderly patient, could be granted privileges by the patient to monitor their follow-up remotely, for example, over the world-wide-web (e.g., an elderly patient can be monitored over the Internet by a family member across the country).

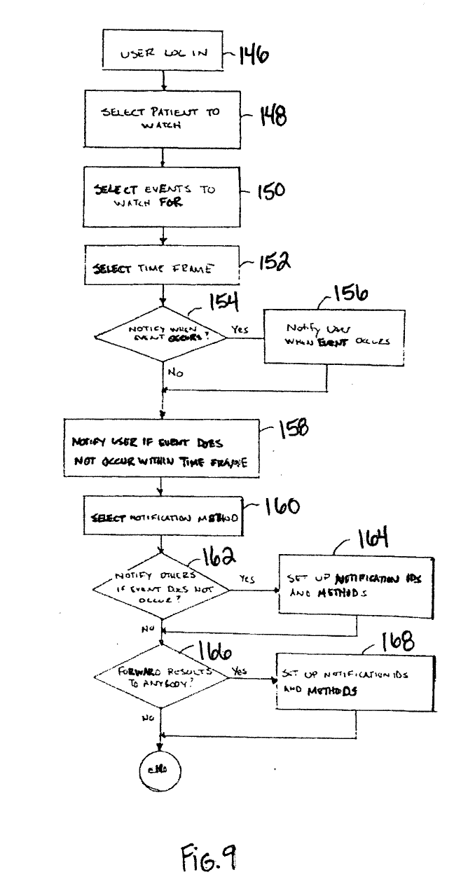

FIG. 9 provides an exemplary flow diagram for setting up such a tracer. The first step 146 involves the user logging into the system similar to the step discussed in step 42 of FIG. 3 and step 90 of FIG. 4. The next step 148 involves a user selecting which patient to watch. This is a similar step as discussed above in step 92 of FIG. 4 and as discussed with respect to FIGS. 5, 6 and 7. In the next step 150 the user selects which events to watch for. This is a similar step as discussed above in step 94 of FIG. 4. In the next step 152, the user selects a timeframe in which to watch such events. In the next step 154, the user selects whether to be notified when the event occurs. If the user wishes to be notified, the system will notify the user when the events occurs as in step 156; and if the user does not wish to be so notified the user will only be notified if the event does not occur within the timeframe as shown in step 158. Thus, if a physician wishes to be paged as soon as a particular test result is available, this step will allow the physician to set up the system to do so. In the next step 160, the user will select a notification method (such as e-mail, pager, telephone, etc.). In the next step 162, the user will be queried whether or not he or she wishes others to be notified if the event does not occur. If others are to be notified, the user is given the ability to set up the notification identifications and notification methods in step 164. In step 166 the user is asked whether or not the system should forward any of the results or reports to any third party. If so, the system will advance to step 168, where the user can set up the notification identifications and methods for notifying such people.

The series of steps described in FIG. 9 may also be performed using the window shown in FIG. 8. In this window, the user may select a particular category such as Radiology, Pathology, Surgery, Lab Results, Clinic Notes or Medication Refill from the list of reports 120. With each selection, the user can, using fields 140, set up a specific timeframe to watch for and select whether or not to be notified with results when the follow up occurs (corresponding to step 158 of FIG. 9). If the user selects no, the user will only be notified if the follow up does not occur. Field 134 may be used to select the notification method, which in this example may be email, pager and/or cell phone. This corresponds to step 164 in FIG. 9. In addition to himself, the user may select certain groups of authorized individuals to receive notification by utilizing drop-down menu 134 (corresponding to step 168 of FIG. 9). These third parties can be such as another authorized family member or one or more scheduling offices within the medical facility, one or more outpatient physician offices, etc. Once all of these fields are entered the user will hit the “Save” button 144 to start the process.

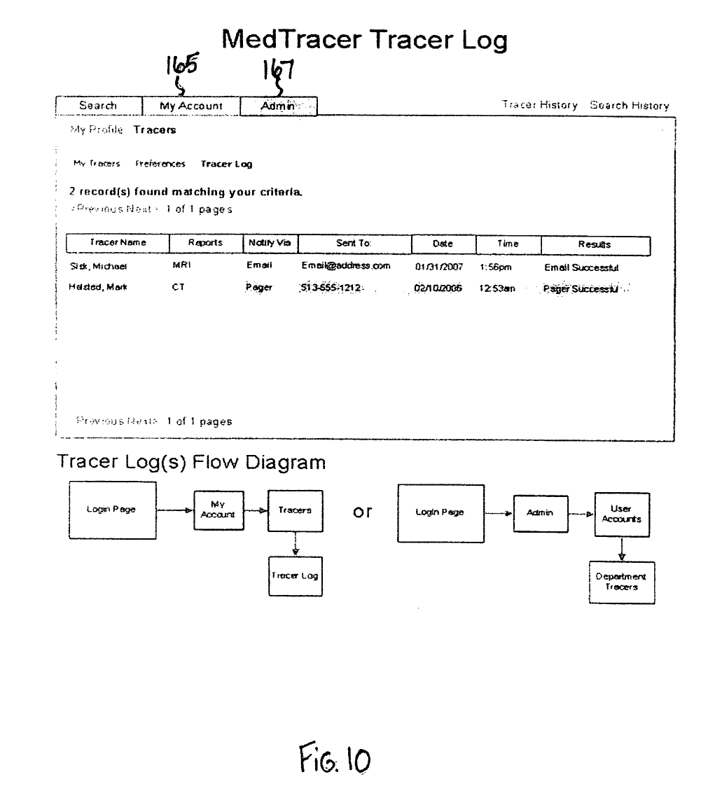

The system of the present invention is also configured to automatically log each and every tracking and watching scenario that is set up and is also configured to log each and every access to patient records. FIG. 10 provides an example of such log. Such logs may be accessed by the individual users (using tab 165), thereby providing such user with a consolidated list of active and/or inactive subscriptions. A log of all use department or even health system wide may be accessible by one or more health system administrators (using tab 167). Such administrative log would be useful to monitor and prevent unauthorized access to patient records.

As already discussed, another important aspect of the exemplary embodiment of the present invention is that it does not limit the tracking, scheduling and notification functions described above to single physician users. All of these functions may be accessible to groups of physicians, departments, discussion groups, practice groups, staff, health system administrator, patients, family members, etc. For example, by selecting from drop-down box 134 (shown in FIG. 8), a user may choose from a list of groups of individuals, departments, etc. to receive results of a particular subscription. To set up such groups, the exemplary embodiment provides a “My Account” page such as that shown in FIG. 12. This template allows a user to set up multiple groups for email and subscription sharing.

To establish and save a new email group, the user first clicks on the “My Account” tab 165 and is taken to the “My Account” page shown in FIG. 12. Then the user clicks on the “Email Group Setup” tab 202. From here, the user may choose to add an entire department to the email group by selecting from drop-down box 204, or may search for one or more individual email addresses to add by typing in the last name of the desired individual in field 206 and clicking the Search button 208. Once a desired address is found, it can be added to the group list displayed in field 210.

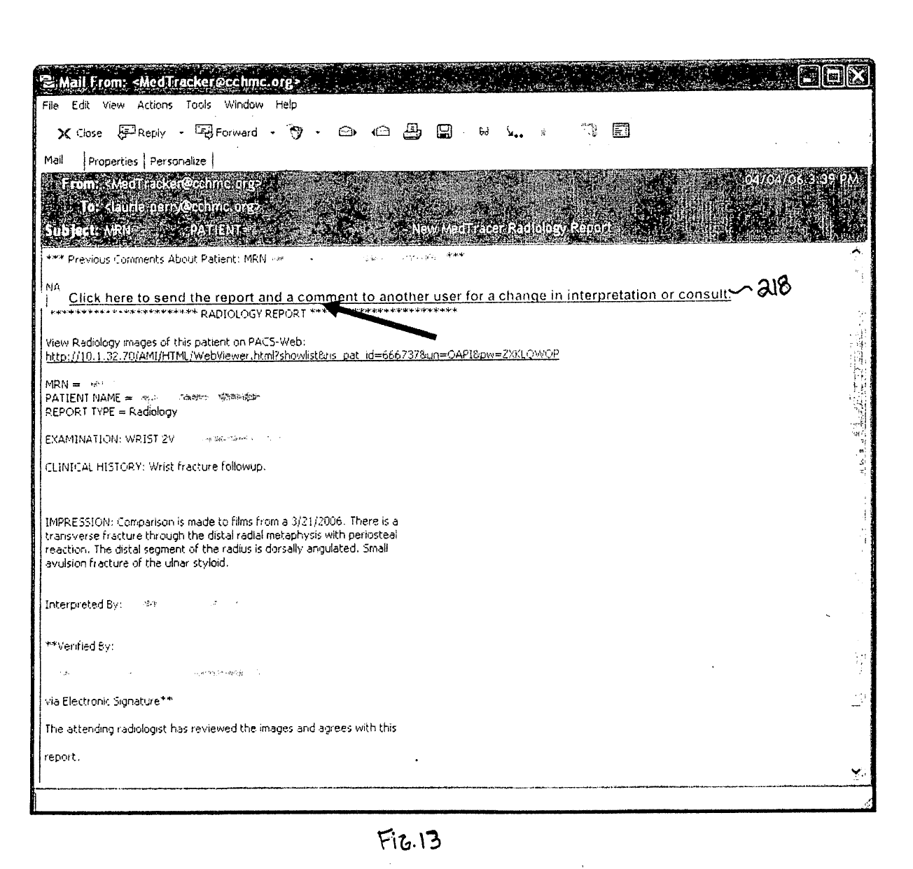

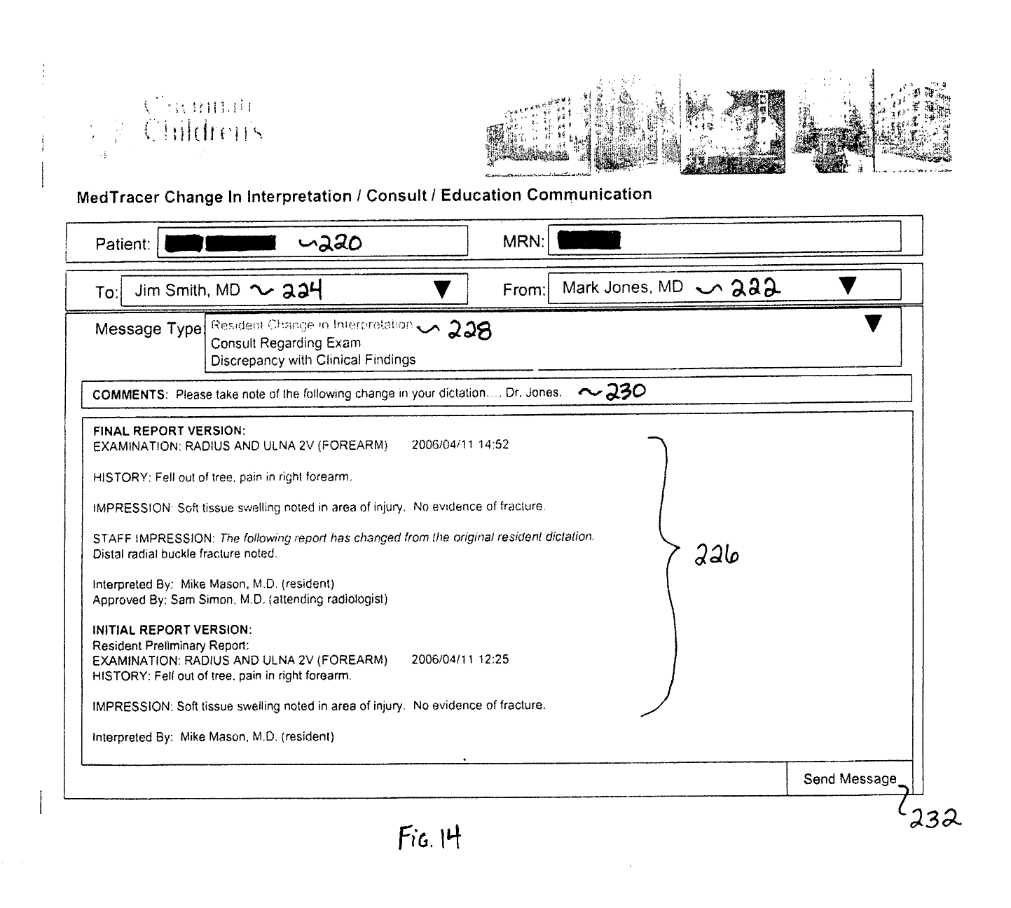

By creating these email-sharing groups, members of the groups may easily share patient record information, seek second opinions, debate diagnoses or treatment options, etc., thereby fostering increased and efficient collaboration. Such sharing may be done by designating groups of individuals to directly receive the results of a particular subscription using drop-down box in 134 in FIG. 9, as already discussed, or by allowing one user to forward a particular notification to another user or group of users. For example, FIG. 13 shows a tracer notification sent to one physician in the form of an electronic report that includes a link 218. By clicking on this link, the physician is taken to a communication template such as the one shown in FIG. 14. The template displays the name of the patient 220 and the name of the physician 222. Physician 222 then chooses an individual physician or group 224 to forward the report 226. In addition to providing a copy of the report 226, physician 222 may identify the reason 228 he or she is forwarding the report and add comments 230 to accompany the report. By clicking button 232, physician 222 sends the report to the individual group or physician 224, who receives it in the form of an email.

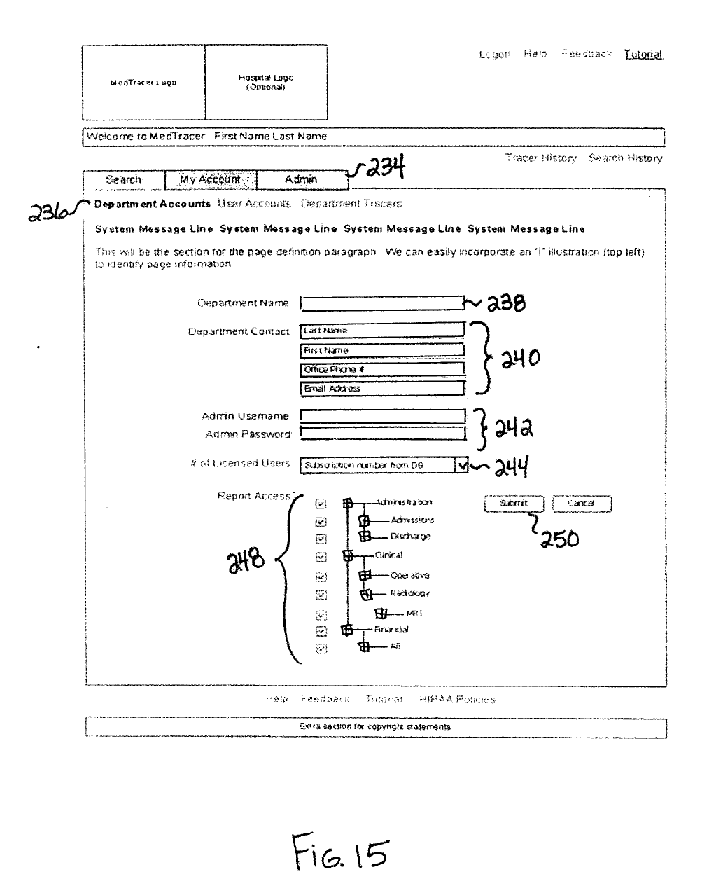

For security and administrative purposes, the exemplary system also allows one or more department or health system administrators to monitor physician and staff access to reports. An administrator may set up this function by clicking on the “Admin” tab 234, and then “Department Accounts” link 236, which takes the administrator to a page similar to that shown in FIG. 15. From here, the administrator enters the name of the department in field 238, department contact information in fields 240, and the administrator's username and password in fields 242 (for security purposes). Then, after selecting the number of licensed users in the identified department in drop-down box 244, and choosing the categories of records to track from field 248, the administrator activates the tracer by clicking on the “Submit” button 250. By doing this, the administrator has created a tracer for tracking department access to the selected records. With increasing federal and state regulation restricting access to medical records and protecting patient privacy, it is very useful for administrators to have a way to detect any abnormally frequent or uncharacteristic access to patient records within a department.

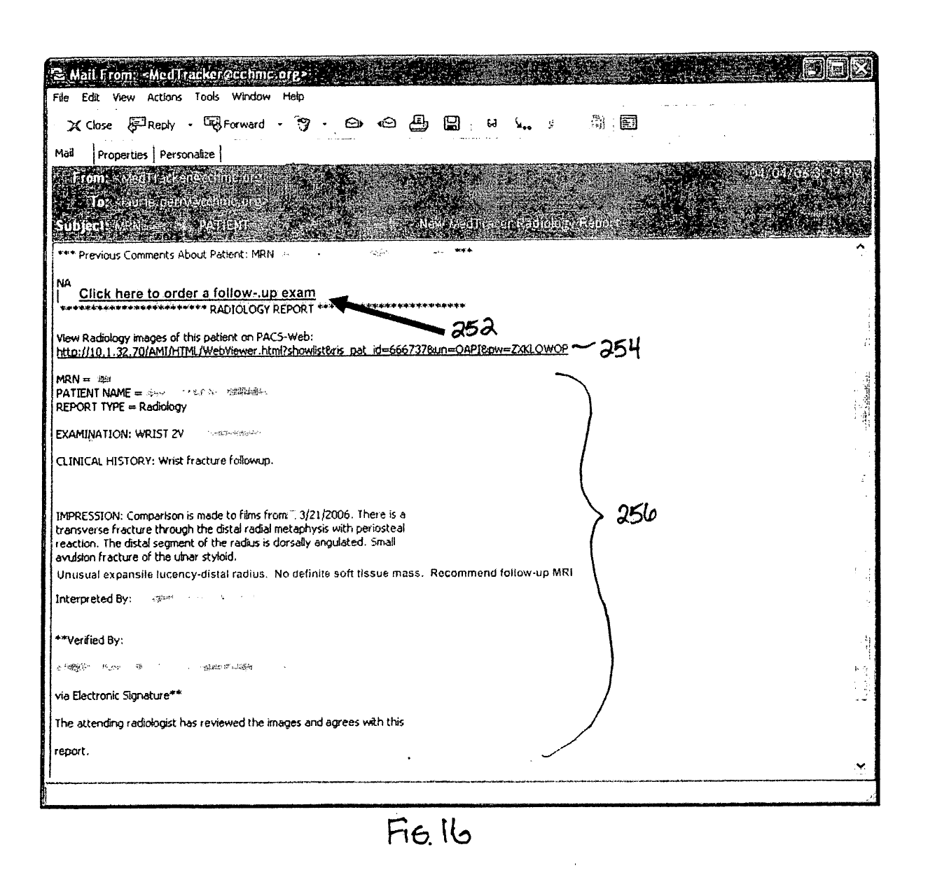

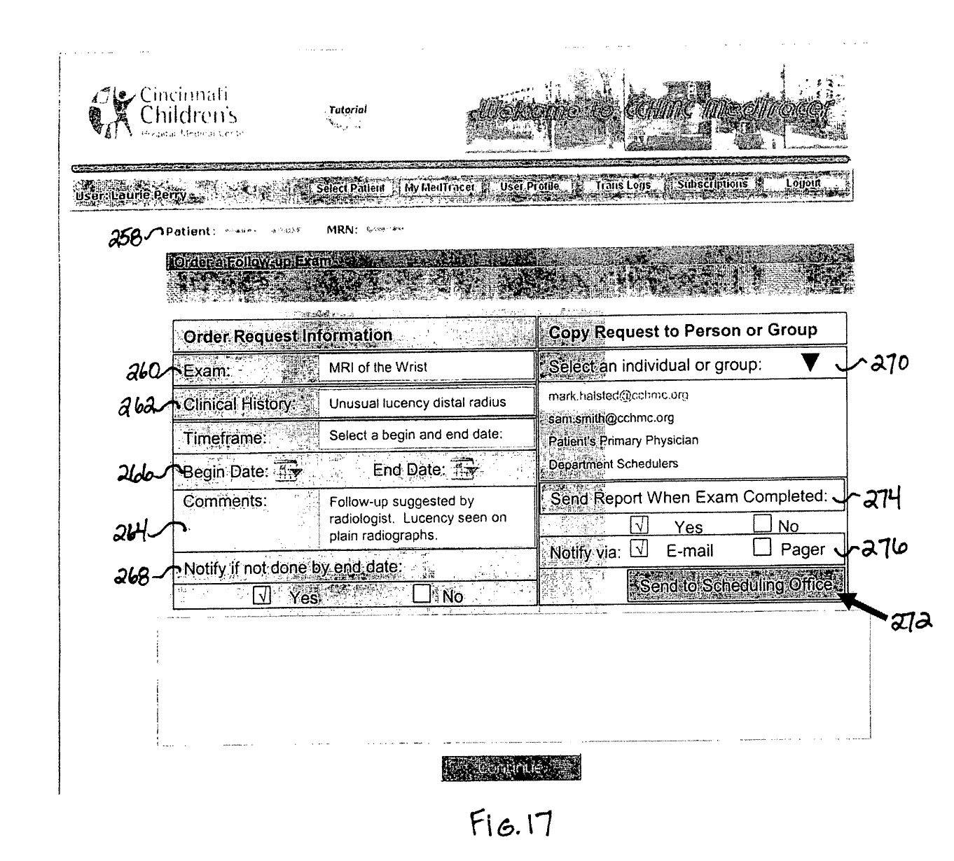

Another important aspect of the exemplary embodiment of the present invention is that it facilitates easy and efficient follow-up ordering of tests, examinations and procedures by integrating an ordering link into an electronic report recommending a follow-up. Such a report is exemplified in FIG. 16. Using the exemplary system, a reporting physician may recommend a follow-up exam in his report 256, which is received by the ordering physician as a tracer notification. By clicking the provided link 252 in the received report, the ordering physician is taken directly to an order template such as that shown in FIG. 17. Such order template could display information such as the patient name 258, the exam requested 260, and a brief clinical history 262. It could also allow the ordering physician to add comments 264 to the order. The ordering physician may then establish a timeframe 266 within which the exam should be completed, checking 268 whether or not he wishes to be notified if the exam is not completed within that timeframe. In addition, the ordering physician may designate other individuals or groups 270 to receive the order requisition. Before sending the order to the appropriate scheduling office by clicking button 272, the ordering physician may specify 274 whether or not he wishes to automatically receive the report when the ordered exam has been completed; and specify 276 the manner in which he will receive such report.

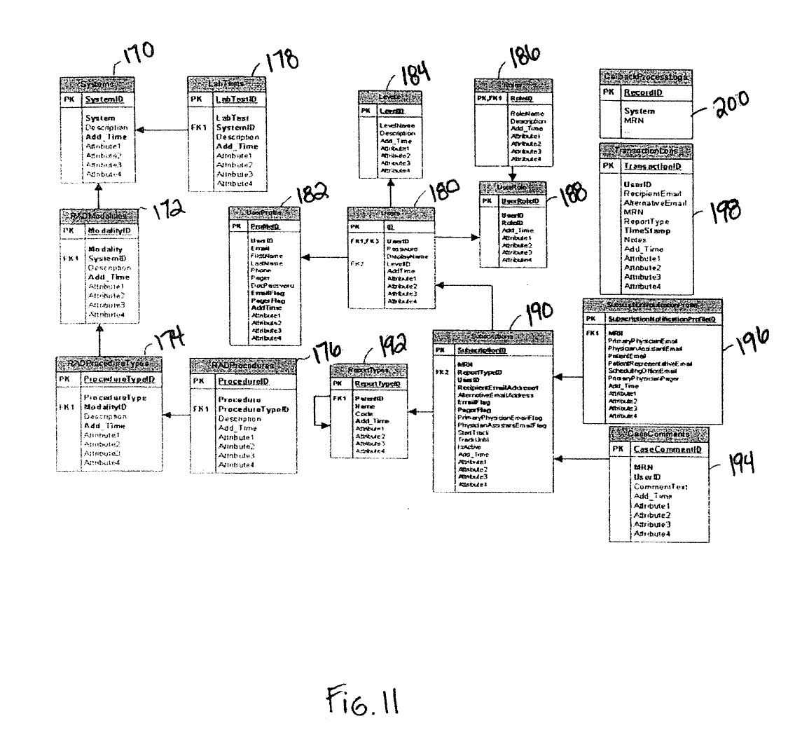

Finally, FIG. 11 provides a database object diagram according to an exemplary embodiment of the present invention, that supports the functionality described herein. The “Systems” object 170 includes report types available for the system of the present invention, such as Radiology, Pathology, etc. The “RADModalities” object 172 includes radiology modality names and their descriptions. The “RADProcedureTypes” object 174 includes radiology procedure type names and their descriptions. The “RADProcedures” object 176 includes radiology procedure names and their descriptions. The “LabTests” object 178 includes available laboratory test names and their descriptions. The “Users” object 180 includes user registration and user level information. The “UserProfile” object 182 includes user profile information, e.g., email address, pager number etc. The “Levels” object 184 includes user levels and level descriptions to support role-based security. The “Roles” object 186 includes user roles and role descriptions to support role-based security. The “UserRoles” object 188 maintains a many to many relationship between Users and Roles to support role-based security. The “Subscriptions” object 190 stores patient report subscriptions based on medical record numbers (MRNs) and report types. The “ReportTypes” object 192 stores the hierarchical structure of report types. The “CaseComments” object 194 stores user comments about patient reports—used by caregivers to remind themselves what interests them about a particular case. The “SubscriptionNotificationProfile” object 196 is used to support additional notification methods. The “TransactionLogs” object 198 is the log book for email and pager transactions. The “CallbackProcessLogs” 200 is a log book for callback processes.

Having described the invention by reference to exemplary embodiments of the invention, it will be apparent to those of ordinary skill that it is possible to fall within the scope of the invention as defined, at least in part, by the following proposed points of novelty without necessarily practicing the exemplary embodiments of the invention. Likewise, it will be apparent to those of ordinary skill in the art that changes can be made to the exemplary embodiments of the invention without departing from the scope of the invention as envisioned in the following proposed points of novelty. It is also to be understood that the following proposed points of novelty are preliminary, and that additional points of novelty may exist even if not recited herein.

What is claimed is:

1. A method for operating a computerized medical information feedback tool comprising the steps of:
providing a medical information brokering system including at least one user computer, and at least one computer server operatively coupled for communication over a computer network, the computer server operating at least a portion of a medical information feedback tool and having access to an electronic patient record database containing a plurality of patient medical records;
logging into the medical information feedback tool using a graphical user interface on the at least one user computer by an authorized user;
subscribing by the authorized user, using the graphical user interface, to one or more target patient medical records and establishing by the authorized user one or more events for the medical information feedback tool to track with respect to the subscribed one or more target patient medical records;
tracking, by the medical information feedback tool, the subscribed one or more target patient medical records for established one or more events; and
automatically notifying the authorized user by the medical information feedback tool in the event that the medical information feedback tool detects at least one of the following: (a) the established one or more events occurs with respect to the subscribed one or more target patient medical records, and (b) the established one or more events fails to occur with respect to the subscribed one or more target patient medical records.

2. The method of claim 1, wherein the notifying step is performed automatically by the medical information feedback tool using one or more of the following:
an electronic mail message;
a pager message;
a telephone communication;
a cellular telephone communication;
a facsimile communication;
an instant message;
a pop-up window communication.

3. The method of claim 1, further comprising the step of automatically storing information pertaining to the logging, subscribing and notifying steps in a central audit database by the medical information feedback tool, such information including at least one of the following:
a date;
a time;
an identity of the authorized user; and
an identity of the subscribed one or more target patient records.

4. The method of claim 1, wherein the established one or more events includes any of the following:
a medical intervention;
a diagnosis;
a referral;
a scheduling of an appointment;
a completion of an appointment; and
a discharge.

5. The method of claim 4, wherein the medical intervention includes one or more of the following:
a treatment;
a test;
a procedure;
an exam;
a prescription.

6. The method of claim 5, wherein the notification step further comprises the step of providing the authorized user with an electronic report regarding the medical intervention by the medical information feedback tool.

7. The method of claim 6, wherein the electronic report is presented to the user in a graphical user interface that includes a recommendation for a follow-up medical intervention and an actuatable item, which upon actuation by the authorized user, provides an intervention-ordering graphical user interface to the authorized user from which the authorized user may order the follow-up medical intervention.

8. The method of claim 7, further comprising the step of routing information entered by the authorized user in the intervention-ordering graphical user interface to a scheduling database.

9. The method of claim 1, wherein the notifying step includes the step of notifying the authorized user by the medical information feedback tool in the event that the medical information feedback tool detects at least one of the following: (a) the established one or more events occurs with respect to the subscribed one or more target patient medical records within a specific time period, and (b) the established one or more events fails to occur with respect to the subscribed one or more target patient medical records within a specific time period.

10. The method of claim 1, wherein the established one or more events is a positive comparison of a completed medical intervention against a recommended medical intervention associated with the one or more target patient medical records.

11. The method of claim 10, wherein the comparison step is performed utilizing natural language processing algorithms.

12. The method of claim 11, wherein the comparison step further utilizes a set of expert rules.

13. The method of claim 12, wherein the completed medical intervention is a positive comparison of the recommended medical intervention if the completed medical intervention is substantially similar to the recommended medical intervention.

14. The method of claim 1, wherein the one or more events includes a positive comparison by the medical information feedback tool of a present diagnosis in the subscribed one or more target patient medical records to a subsequent diagnosis associated with the one or more target patient medical records.

15. The method of claim 1, wherein the one or more events includes a positive comparison by the medical information feedback tool of a present diagnosis in the subscribed one or more target patient medical records to a subsequent diagnosis associated with the one or more target patient medical records.

16. The method of claim 15, wherein the comparison step is performed utilizing natural language processing algorithms.

17. The method of claim 1, further comprising the steps of:
monitoring, by the medical information feedback tool, the plurality of patient medical records for extraordinary events; and
upon detection of an extraordinary event in the monitoring step, automatically notifying the authorized user of the extraordinary event.

18. The method of claim 17, wherein the extraordinary event is taken from a group consisting of: a diagnosis of a highly contagious disease and a test result indicating the existence of a highly contagious disease.

19. The method of claim 18, further comprising the steps of:
automatically identifying the patient medical record associated with the extraordinary event by the medical information feedback tool;
automatically identifying by the patient medical record feedback tool, from the identified patient medical record, employees of a healthcare facility that may have come into contact with the highly contagious disease; and
automatically notifying by the medical information feedback tool the identified employees of the diagnosis.

20. The method of claim 19, wherein the step of automatically notifying the identified employees further includes providing the identified employees with instructions.

21. The method of claim 17, wherein the extraordinary event is taken from a group consisting of: a substantially usual diagnosis and a substantially unusual test result.

22. The method of claim 17, wherein the monitoring step is performed utilizing natural language processing algorithms.

23. The method of claim 22, wherein the monitoring step further utilizes a set of expert rules.

24. A method for operating a computerized medical information feedback tool comprising the steps of:
providing a medical information brokering system including at least one user computer and at least one computer server operatively coupled for communication over a computer network, the computer server operating at least a portion of a medical information feedback tool and having access to an electronic patient record database containing a plurality of patient medical records;
logging into the medical information feedback tool using a graphical user interface on the at least one user computer by an authorized user;
subscribing by the authorized user, using the graphical user interface, to one or more target patient medical records and establishing by the authorized user one or more events for the medical information feedback tool to track with respect to the subscribed one or more target patient medical records;
subscribing by the authorized user, using the graphical user interface, one or more recipients of notification information;
tracking, by the medical information feedback tool, the subscribed one or more target patient medical records for established one or more events; and
automatically notifying the one or more recipients by the medical information feedback tool in the event that the medical information feedback tool detects at least one of the following: (a) the established one or more events occurs with respect to the subscribed one or more target patient medical records, and (b) the established one or more events fails to occur with respect to the subscribed one or more target patient medical records.

25. An event notification method for a healthcare facility comprising the steps of:
providing a medical information event notification system including at least one user computer and at least one computer server operatively coupled for communication over a computer network, the computer server operating at least a portion of a medical notification software tool and having access to a patient record database containing a plurality of patient records;
monitoring the plurality of patient records by the medical notification software tool for at least one predetermined event; and
performing one or both of the following steps,
(a) upon detecting the occurrence of at least one predetermined event by the medical notification software tool, automatically pushing a notification of the detected predetermined event occurrence to an authorized user of the medical information event notification system; and
(b) upon detecting the non-occurrence of at least one predetermined event by the medical notification software tool in a predetermined window of time, automatically pushing a notification of the detected predetermined event non-occurrence to an authorized user of the medical information event notification system.

26. The method of claim 25, further comprising the step of, prior to the monitoring step, subscribing the authorized user to the at least one predetermined event.

27. The method of claim 26, wherein the predetermined event is a test result.

28. The method of claim 26, wherein the predetermined event is a diagnosis.

29. The method of claim 26, wherein the predetermined event is the scheduling of a medical appointment.

30. The method of claim of 26, wherein the predetermined event is the occurrence of a medical appointment.

31. The method of claim 25, wherein the predetermined event is a difference between an initial diagnosis and a subsequent diagnosis.

32. The method of claim 25, wherein the predetermined event is a confirmation between an initial diagnosis and a subsequent diagnosis.

33. The method of claim 25, wherein the predetermined event is a diagnosis of a communicable disease.

34. The method of claim 25, wherein the predetermined event is a potential duplication of one or more of an ordered test, exam and procedure.

35. The method of claim 25, wherein the predetermined event is a detected discrepancy in a patient's medical record.

36. The method of claim 25, wherein the notification is in the form of one or more of the following: an email, an electronic page, a telephone call, a voice-mail, and a fax.

37. The method of claim 25, wherein the authorized user is a family member of a patient.

38. The method of claim 25, wherein the authorized user is a referring physician.

39. A computer implemented medical event notification system comprising:
a computer network;
at least one user network device operatively coupled for communication over the computer network; and
at least one computer server operatively coupled for communication over a computer network, the computer server operating at least a portion of a medical notification software tool and having access to a patient record database containing a plurality of patient records;
wherein the medical notification software tool is programmed to perform at least the step of monitoring the plurality of patient records for at least one predetermined event, and is further programmed to perform at least one or both of the following steps,
(a) upon detecting the occurrence of the at least one predetermined event, automatically pushing a notification of the detected predetermined event occurrence to an authorized user of the medical information even notification system; and
(b) upon detecting the non-occurrence of the at least one predetermined in a predetermined window of time, automatically pushing a notification of the detected predetermined event non-occurrence to an authorized user of the medical information event notification system.

40. The computer implemented medical event notification system of claim 39, wherein the at least one user network device is taken from a group consisting of: a desktop user computer, a laptop user computer, a handheld computer device, a cellular device, and a pager device.

41. The computer implemented medical event notification system of claim 39, wherein the medical notification software tool is further programmed to perform at least the step of the step of, prior to the monitoring step, subscribing the authorized user to the at least one predetermined event.

42. The computer implemented medical event notification system of claim 39, wherein the predetermined event is taken from a group consisting of: a test result, a diagnosis, the scheduling of a medical appointment, the occurrence of a medical appointment, a difference between an initial diagnosis and a subsequent diagnosis, a confirmation between an initial diagnosis and a subsequent diagnosis, a diagnosis of a communicable disease, a potential duplication of one or more of an ordered test, exam and procedure, and a detected discrepancy in a patient's medical record.

43. The computer implemented medical event notification system of claim 39, wherein the notification is in the form of one or more of the following: an email, an electronic page, a telephone call, a voice-mail, and a fax.

44. The computer implemented medical event notification system of claim 39, wherein the medical notification software tool includes a natural language processing function for use in detecting the occurrence or non-occurrence of the at least one predetermined event.
